(19) United States
(12) Patent Application Publication
(10) Pub. No.: US 2010/0281108 A1
(43) Pub. Date: Nov. 4, 2010

(54) Provision of Content Correlated with Events

(76) Inventor: Ronald H. Cohen, (US)

Correspondence Address: LAW OFFICE OF ERIC B. ALSPAUGH, 26895 ALISO CREEK ROAD SUITE B 223, ALISO VIEJO, CA, 92656, US

(21) Appl. No.: 12/772,065

(22) Filed: Apr. 30, 2010

Related U.S. Application Data
(60) Provisional application No. 61/174,809, filed on May 1, 2009.
(60) Provisional application No. 61/178,759, filed on May 15, 2009.
(60) Provisional application No. 61/228,085, filed on Jul. 23, 2009.
(60) Provisional application No. 61/267,032, filed on Dec. 5, 2009.
(60) Provisional application No. 61/299,885, filed on Jan. 29, 2010.

(51) Int. Cl. G06F 15/16

(52) U.S. Cl. 709/203

(57) ABSTRACT

The invention relates to providing time-varying information synchronized with real-world events or time-based media.

### CROSS-REFERENCE TO RELATED APPLICATION

U.S. provisional application Nos. 61/174,809 filed May 1, 2009, 61/178,759 filed May 15, 2009, 61/228,085 filed Jul. 23, 2009, 61/267,032 filed Dec. 5, 2009, and 61/299,885 Jan. 29, 2010 the contents of which are hereby incorporated by reference.

### BACKGROUND OF THE INVENTION

Various techniques have been described in the relevant art for implementing interactive television. These techniques have various shortcomings that are overcome by the current invention.

Some prior relevant art involves embedding enhancement content (content that is displayed concurrent with a television program) or timing information in the same information stream that carries a television program, and then decoding this information and displaying the enhancement content either on the same device that displays the television program or on a separate device that is communication with the decoding means. This type of technique often involves a set-top box or a device capable of simultaneous display of the television program and the enhancement content. The present invention obviates the need for a set-top box, for a device that can simultaneously display television content and enhancement content, and for communication or connection between the enhancement display device and the television or set-top box. The present invention provides a system with no communication between the enhancement device (which may be, for example, a mobile phone, tablet computing device, or computer) and either a television or set-top box. Some prior relevant art involves real-time modification of web pages by the device displaying the content. The present invention obviates the need for such modification.

Some prior relevant art involves detection of the time of a user request and using such time to determine the content to send to a user. The present invention obviates the need for these functions.

Some prior relevant art involves embedding synchronization information or enhancement content in a video stream, and further extracting such information or content, in order to provide enhancement content synchronized with the video stream. The current invention obviates the need for these functions.

Some prior relevant art involves selection of content to provide to a user based on a user selection. The current invention obviates the need for such a selection.

Some prior art involves the synchronization of at least two data streams, e.g. a television content stream and an enhancement data stream. The current invention obviates the need for any such synchronization.

These and all other referenced patents are incorporated herein by reference in their entirety. Furthermore, where a definition or use of a term in a reference, which is an incorporated reference here, is inconsistent or contrary to the definition of that term provided herein applies and the definition of that term in the reference does not apply.

Although various improvements are known to the art, all, or almost all of them suffer from one or more than one disadvantage. Therefore, there is a need to provide improved road bollards and methods of adapting existing road bollards.

### SUMMARY OF THE INVENTION

The present invention comprises multiple aspects that can be used, separately or in combination, to provide interactive content to a user concurrent with and in relation to broadcast content (e.g. a television program) or a live event (e.g. a sports event or concert). These aspects include:
Client-Side Sequenced Aspect
Unsequenced Aspect
Server-Side Sequenced Aspect
Mixed Sequenced and Unsequenced Aspect
Chained Sequence Aspect
Real-Time Media Sample Synchronization Aspect
Content Determination Aspect
Application vs. Browser Aspect
Voice Recognition Aspect
Content Population Aspect
Gaming Aspect

It is to be understood that the foregoing general description and the following detailed description are exemplary and explanatory only and are not to be viewed as being restrictive of the present invention, as claimed. Further advantages of this invention will be apparent after a review of the following detailed description of the disclosed embodiments and in the appended claims.

### DETAILED DESCRIPTION OF THE PREFERRED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented to provide what is believed to be the most useful and readily understood description of the principles and conceptual aspects of the invention.

A first preferred embodiment is described as follows:

Glossary

“User” means a human being that uses a Client.

“Client” means a device that displays content to a User and that has a connection to a network such as the Internet. Typically a Client will include a web browser. A computer, a browser-equipped mobile telephone, and a tablet computer are examples of Clients.

“Media Stream” means an object of time-based media, for example, audio or video. A Media Stream may be in digital or analog format.

“Enhancing Content” means information, provided to a Client that is related to a Media Stream or to a live event, such as a concert or sports event. The Enhancing Content can be web pages or other content provided via a network such as the Internet. Items of Enhancing Content can presented to the User at a times close to identical with related Media Stream content, such that the Enhancing Content enhances the Media Stream content.

Client-Side Sequenced Aspect

A Client can download a sequence from a Server, for example the sequence can be an instruction from the server. The instruction can be as simple as to download a web addresses at a particular time from a sequence list. A sequence list could be a list of web addresses and an associated amount of time with each web address. Alternatively, the instruction could be to poll the server in a defined manner (whether time dependent or other). The sequence can include information addresses, such as Internet URLs, and for each such address, an associated time. The Client can download and display information from the addresses in the sequence at the times associated with such addresses. Furthermore, the Client can download information from such addresses prior to the associated times, can store the downloaded information locally in the Client, and then can display the information at each such associated time. Such preloading enables the information to be displayed more precisely at a desired time, without delay due to downloading. This client-side sequence function can be implemented in software in the Client. A language such as JavaScript can be used for this functionality. The downloaded information can be web content. The downloaded information can be stored or displayed in an iframe or other buffer (herein the term “iframe” means any such buffer or mechanism). Such an iframe can be set to be invisible by such software prior to the time that the information is scheduled to be displayed, according to the sequence. The iframe can then be set to be visible at the scheduled time according to the sequence. In this manner the content is not visible while it is being downloaded, the content appears at the scheduled time to the User, and the downloading period is either not visible or minimal to the User. At least two iframes can be used, such that one iframe is visible while content is being downloaded into the other invisible one. Other software techniques, other than just iframes, can be used to create and utilize buffers that may be made visible and invisible, for downloading and display of information. The term “updates” as used herein means to send information whether by refreshing, updating a file, re-writing a file, deleting a file, amending a file, web content, web address and is not intended to limit any process by which a server and client device communicate.

The following technique enables entire web pages to be downloaded and displayed without modification. The client-side software implementing the above functions can operate within a web browser within the Client. Such client-side software can be downloaded to the client within a web page, by a reference within a web page, or by other means. This technique enables a web page from any Internet domain to be displayed by the Client, including a web page in a domain different than that of the page that the Client originally accessed to start the process, or different from the domain from which software implementing the process was downloaded to the Client. This is because a web page can contain both the client-side software and the at least one buffer (e.g. iframe) in which other web pages are contained. The client-side software can thus command the at least one buffer to access or display information at any address. A sequence can be downloaded to a Client in a manner such that it is not downloaded all at once. The Client can download only the next event in a sequence, process that event (download Enhancing Content related to that event), optionally cache the Enhancing Content prior to display, display the Enhancing Content, and then repeat the process by downloading the next event in the sequence, and so on. Similarly, a Client can download and process more than one event in a sequence at time. For example, multiple web pages can be downloaded and cached prior to display.

Unsequenced Aspect

This aspect provides Enhancing Content, to a Client, without the need for a sequence or components that utilize a sequence. This aspect is useful if the Media Stream or live event is unpredictable, in which case determining sequenced Enhancing Content is difficult or impossible. For example, it is difficult (usually) to predict the events within a sports game a priori. In this aspect, the Client periodically polls a source of Enhancing Content and, if new Enhancing Content is detected, downloads the new Enhancing Content and displays it to the User. The source of the Enhancing Content can be at least one server, such as a web server. The Client can poll the server at regular or irregular intervals. The Client can poll the server by sending a message requesting the time of modification of the content on the server. By comparing this time with the time of the most recent content previously downloaded to the Client, the Client can determine whether the content on the server is more recent than that most recently downloaded. If the content on the server is newer than that most recently downloaded, the Client can download the new content from the server and display it to the User. The Client can determine the time of modification of the content on the server by sending a HTTP HEAD request to a web server and reading the most recent content modification time from the HTTP response headers returned from the server. This technique involves relatively little data transfer and is highly efficient. New Enhancing Content can be provided to the Client by changing the content on a server. For example, a Client can poll a server for updates to a web file named “a.html.” When it is desired to change the Enhancing Content, the file a.html can be replaced, on the server, with a new file. When the new file is downloaded to the Client the new Enhancing Content can then be displayed. Such file update can be done by editing the original file, replacing it with a new file, creating a pointer from the original file to the new file (herein a “pointer” means any reference, alias, software pointer, address redirection, etc. that causes an access request for one object to be redirected to another object) or other technique that causes the Client, upon subsequently polling for the original file, to access the new file. Such a file update can be affected via operating system commands, FTP (File Transfer Protocol) commands, or other commands issued to or in the server. A Client can perform polling by JavaScript, HTML Meta refresh, or other software or hardware techniques.

Use of Caching

Content caching can be used to provide timely content updates to large numbers of Clients. In embodiments using caching, a plurality of servers, known as a “content delivery network,” can serve as an intermediary layer between a server that holds the original content (the “origin server”) and the Client devices. Copies of the content are served by the content delivery network servers, thus enabling greater aggregate traffic than would be possible by using only the origin server. The content delivery network can poll the origin server so that when the content is updated on the origin server the new content is propagated to the content delivery network and then to the Client(s).

Server-Side Sequenced Aspect

A server can hold, store, or access a sequence. The sequence can comprise a list of information addresses, such as Internet URLs, and a time associated with each address. A Client can operate according to the “Unsequenced Aspect” described above, in which case the Client does not have sequence information but rather can periodically poll the server to ascertain the presence of and/or download new content when it is available. The server can make the new content available, according to the sequence, by updating a file, symbolic link, or other mechanism. In such an embodiment the entire system can provide a sequence of Enhancing Content utilizing sequence information that is in a server and not in a Client.

Hybrid Sequenced and Unsequenced Aspect

This aspect involves using both sequenced and unsequenced aspects together. A Client can download a sequence, as described in “Client-side Sequenced Aspect” above. A part of the sequence can comprise operation in the Unsequenced Aspect mode, in which the Client polls the server to obtain new Enhancing Content. For example, a Client could display sequenced Enhancing Content for a 5-minute period (using the Client-Side Sequenced Aspect), and then poll a server for new Enhancing Content for a subsequent 5-minute period, and then display sequenced Enhancing Content for another 5-minute period (again using the Client-Side Sequenced Aspect). The various aspects (Client-Side Sequenced, Unsequenced, and Server-side Sequenced) can be combined in any order, quantity, or combination. Aspects can be encoded within or specified by a sequence. A Client can operate according to a sequence. A sequence can specify that certain information addresses are to be accessed at their associated times and that other times (or another time period) the Client should poll for Enhancing Content, according to the Unsequenced Aspect. For example, the example provided in the preceding paragraph can be specified in a sequence.

Chained Sequence Aspect

Sequences can be logically connected in a “chain” comprising several sequences. A Client can download multiple sequences. The Client can execute such multiple sequences sequentially. A Client can download such multiple sequences all at the same time. Alternatively, a Client can download the next sequence in the chain while still within a “current” sequence. This latter approach can reduce client resource utilization and can allow for subsequent sequences to be modified closer in time to the time of their actual display by a Client. This Chained Sequence Aspect also applies to Server-Side Sequences, in which case the sequences are not downloaded but are utilized on the server.

Real-Time Media Sample Synchronization Aspect

In order to provide Enhancing Content pertinent to a Media Stream, the identity of the Media Stream should first be determined. This can be done via sound recognition. A Client can detect a sample of ambient sound. The sound sample can be sent to a server. The sound can be compared to a database of sounds or data derived therefrom and thus identified. Such sound recognition can be performed in the Client or in a server or other device. To reduce the resources needed to store and compare sound samples against a large sound database, the sound database can be created in real-time. This can be done by capturing sounds in real-time, storing them in a database, and deleting sounds older than some limit from the database. In this manner the sound database size is limited and the amount of database sounds to which input sounds samples are compared against is limited. Sounds can be captured from a broadcast, e.g. a television station, and stored in the database. Sounds can be captured from multiple broadcasts. Sounds older than some limit can be deleted from the database. By comparing a sound sample to the database, the identity of the Media Stream and the location or time within the Media Stream can be identified. Such sound recognition can be used to identify a real-world event or a position in time within such a real-world event by comparing a sound sample captured by a Client to a database of sounds known to be present at one or more real-world events.

Content Determination Aspect

In order to provide Enhancing Content pertinent to a real-world event, the identity of the real-world event should first be determined. As described above, this can be done via sound recognition. However, this can be problematic due to ambient noise or the lack of a sound known to be present in the real-world event. The real-world event can be identified via means other than sound recognition and, based on such identification, the Client can be provided with an information address from which the Enhancing Content can be obtained or start to be obtained.

A User can enter an information address, corresponding to a real-world event, into a Client and the Client can then access information at this address. The information address can be provided to the User by, for example, displaying it on a sign, scoreboard, screen, etc., by presenting it via an audio announcement, or by sending it to a User or the Client via a message (e.g. email or text message). A Client can access a network, such as a radio-frequency network (e.g. WiFi). Such a network can include transponders, base stations, access points, or other such connection point(s) in the vicinity of the real-world event. If a Client is connected through such a connection point provided by or in the vicinity of the real-world event then that fact can be used to deduce that the Client is in the vicinity of the real-world event and thus the Client can be provided with an information address of the Enhancing Content for the real-world event. For example, a stadium can be equipped with WiFi access points, a User can cause a Client device to connect to the WiFi network, and then content pertinent to the event in the stadium can be provided to the Client based on the knowledge the Client has connected to a WiFi access point in or near the stadium. The correspondence between a Client and a real-world event can be determined from the Client's location. The Client's location can be determined via GPS (Global Positioning System), radio-frequency means, or other means. By correlating the Client location with that of a real-world event, the Client can be provided with an information address of Enhancing Content pertinent to the real-world event. This aspect can be used to provide information related to stores, buildings, entertainments, or other real-world objects or events. A user can select a TV channel or other content identifier. This selection can be used to determine the Enhancing Content that is provided to the Client.

Direct Information Access Aspect

Elsewhere in this document, reference is made to providing Enhancing Content to a Client by first providing an information address to a Client and then the Client accessing the Enhancing Content at that address. Information (e.g. Enhancing Content) can be provided directly to a Client without first providing an information address and then the Client accessing information at the address. This can be done by sending the information directly to a Client, e.g. from a server.

Voice Recognition Aspect

Voice recognition can be used to accept inputs from the User such that the User can interact with Enhancing Content, a real-world event, or a Media Stream via voice. Voice recognition can be used to enable a User to provide comments on a Media Stream, real-world event, or Enhancing Content. Such comments can be shared among multiple Users. Users can engage in a dialog or stream of comments by using voice recognition to provide comments, via voice, that are converted to text.

Content Population Aspect

Enhancing Content can be determined or created automatically by using an algorithm that automatically selects content related to a Media Stream, real-world event, or User preferences. For example, if a User is watching a particular television show then Enhancing Content related to that show or the particular portion of the show currently being watched can be provided to and displayed by the Client (e.g. information on show characters or actors, voting opportunities, game show participation by User, shopping opportunities for goods or services related to the show (e.g. music, video)). Real-time Internet search can be used to provide relevant Enhancing Content. Advertising related to a Media Stream, real-world event, or User preferences can be provided by such an automated system. Space for such advertising can be sold via an auction. Such an auction can be automated. For example, advertisers can bid for advertising space in Enhancing Content that will be displayed to Users during a particular show (e.g. television show), real-world event, sports event, etc. or at a particular time in such show or event.

Gaming Aspect

Enhancing Content can include a game. Enhancing Content can include gambling or betting via which Users can bet on a real-world event, such as a sports event.

A second preferred embodiment is described as follows:

Computing devices often include capabilities to access and display various types of content information (“content”), including web sites, text, graphics, audio, and video. Users conventionally navigate from a first content item to a second content item via a hyperlink embedded in the first content item. This requires insertion of hyperlinks into the content and the use of software to detect and extract the hyperlink information. In many cases, the content in its original form does not include such hyperlinks. Furthermore, the insertion, detection, and extraction of the hyperlink information can be costly in terms of computation and human labor. Insertion and detection of conventional hyperlinks in text and graphics is a common practice. Hyperlinked media commonly use the location of a User's pointing device, such as a mouse, to detect the object that a User is interested in. A hyperlink is then extracted from that object. Insertion of hyperlinks into more complex media, such as audio and video, is relatively complex. Audio inherently does not enable a User to “point” to a location. Audio recognition can be used to recognize the content that a User is interested and the time within that content. However, audio recognition is technically complex and more expensive than conventional text and graphic hyperlinks. Hyperlinking from video can be accomplished by detecting the point within a video that a User activates (“clicks”) a pointing device. This involves software to detect the time or frame position within the video, and the video content must be encoded with time or frame information compatible with such software. There is a need for a method for hyperlinking of such time-based media content without the cost and complexity associated techniques conventionally applied for such purpose.

Some aspects or embodiments of the inventive subject matter involve a system including multiple functions. These functions can each be incorporated into distinct devices (i.e., one function per device), they can all be incorporated into one device, or they can be arbitrarily distributed among one or more devices. Throughout this description of the inventive subject matter any reference to such functions or devices includes the implication that such functions can be arbitrarily distributed among one or more devices and that multiple devices can be combined into fewer devices or one device. Furthermore, the functions can be arbitrarily assigned to different devices, other than as described herein. In embodiments in which the devices are distinct or distal, the devices can be connected via network such as the Internet.

One aspect of the inventive subject matter comprises a system and process for accessing information pertinent to a portion of an object of time-based media (the “Content of Interest”). The Content of Interest can be an object of audio, video, or another type of media content or object that has a time aspect. The Content of Interest is resident, displayed by, played by or otherwise presented via a First Device. Hereinafter, “playing” or “played” is used to mean all such terms involving content being stored or presented in or via a device. If the Content of Interest is audio content then the First Device can be a device capable of playing audio content. If the Content of Interest is video content then the First Device can be a device capable of playing video content. In general, the First Device presents the content to a User, which can be a human being or another device. The identity of the Content of Interest is sometimes referred to herein as the “Content Specifier.” The First Device can provide the Content Specifier to the User or to a Second Device, or a User can provide the Content Specifier to the Second Device. The Content Specifier can be, for example, a television channel, a radio channel, a radio frequency, an Internet site address, a URL, the identity of a specific content item (e.g. of a particular item of video or audio content), or other identifier. In some embodiments a User, device, or software process specifies a Content Specifier to the Second Device. For example, in embodiments in which the First Device displays streaming audio or video content (e.g. a television set or radio) and the Second Device is a mobile telephone, the User can specify a television or radio channel. The User selects, via a Second Device, a portion of the Content of Interest that is of particular interest. For example, the User specifies a specific time within an item of audio or video content by clicking with a mouse, pressing a button, making a screen entry, or otherwise providing a command or taking some action. The time at which the User takes this action (the “Content Selection Time”) is sent from the Second Device to a Third Device. The Content Specifier is sent from the Second Device to the Third Device. Furthermore, the User can provide a command that is sent from the Second Device to the Third Device.

The Third Device receives from the Second Device the Content Selection Time, the Content Specifier, or a command. The Third Device determines the Content of Interest (or particular portion thereof) based on the Content Specifier, the identity or an address of the Second Device, the Content Selection Time, or knowledge of which portion of the Content of Interest was being played via the First Device at the Content Selection Time. Based on the identity of the Content of Interest and the particular point within the Content of Interest, the Third Device determines additional information or an address of additional information and sends such to the First Device or Second Device.

For example, in one embodiment the First Device can be a television set, the Second Device can be a mobile telephone with Internet access, and the Third Device can be a server with access to the start and end times of television content, or portions thereof, playable by the television set. A User desiring access to information pertinent to a particular portion of television content can provide, via the mobile telephone, the channel or other identification of the content. The User can provide a command, to the mobile telephone, at the time that the User sees or hears the content the User is interested in, by pressing a button, making a selection on a screen, making a gesture, providing voice input, or other action. The mobile telephone sends to the server a) the time that the User made this action and b) the television channel or other identifier of the content that is being displayed by the television set. The server determines the specific content that the User is observing or interacting with by i) determining the content channel based on the Content Specifier (item b above), ii) determining the specific content in that channel based on knowledge of what content is being broadcast, transmitted, played, or sent on that channel at the Content Selection Time (item a above), or iii) comparing the Content Selection Time with the start and end times of content provided on the content channel that User is observing. The server determines information associated with the point within the content at which the User interacted, based on start and end times of portions of the content. Furthermore, the selection, determination, or creation of information can be based partly or completely on a command sent from the second device (in this example a mobile telephone) to the third device (in this example a server). The second device can, in some embodiments, access information in a database, such as the start and end times of portions of television content, the television channels on which such content is broadcast, and information addresses associated with the portions of content (such audio or video content). The online information addresses can be web site addresses. The Third Device (e.g., server) can provide the online information to the User by sending the information itself or the address of the online information to the Second Device (e.g., mobile telephone), which can then access the online information. Such online information can be a web site. The address of the online information can be a web site address, podcast address, or other Internet address (e.g., a URL).

In another embodiment of the inventive subject matter, the time-based media can be audio content. The process and system in this case is similar to that described above but except that the First Device plays audio content rather than video content. Another aspect of the inventive subject matter is a technique that eliminates the need for a User to provide a Content Specifier as described above. The Content Specifier specifies the media stream or media source that contains the Content of Interest, and can be a television channel, a radio channel, or an Internet streaming media site address, etc. In the television example described above, the User can provide the Content of Interest, for example, by entering a television channel into the Second Device. In some embodiments the First Device can send the Content Specifier to the Second Device via radio frequency, optical, wire, or other communication means. In such embodiments the Content Specifier can represent the content channel that is being played by the First Device. In such embodiments, since the Content Specifier is provided to the Second Device by the First Device, it is not necessary for a User to provide the Content Specifier. For example, the First Device can be a television set and the Second Device can be a mobile telephone. The television set can send, to the mobile telephone, the identity of the channel that is being played by the television set, via radio frequency communication (e.g. Bluetooth), infrared or optical communication, wire transmission, optical character recognition, or other means. Upon observing television content of interest the User provides a command to the mobile telephone, which then sends the Content Specifier, (the television channel, in some embodiments), the time of the command, or a command from the User or Second Device, to the server. The server then provides to the mobile telephone the pertinent online information or an address thereof as described above.

Another aspect of the inventive subject matter is the First Device sending, in addition to the Content Specifier, the time within the content that is currently being played, displayed, or otherwise processed, to the Second Device. “Time within the content” means the time from the start of an item of time-based media to a point within the media item as measured in the time scale of the media item. The Second Device can send the Content Specifier and the time of a User command time, as measured within the content, to the Third Device. The Third Device can then determine, based on the Content Specifier, the command time within the content, or the command itself, pertinent information or an address of such pertinent information and can send such pertinent information or address thereof to the First Device or Second Device. This technique can enable information access from time-based media without the need for knowledge of the actual clock time that a User makes a command or for synchronization of time between a media content source and a device playing the content. Instead, this technique uses the time within the content, as provided by the First Device. For example, the First Device can be a computer, television, or other device playing time-based media content and the Second Device can be a mobile telephone. The First Device can send or broadcast at least one time data item indicating the time within at least one item of audio or video content that the First Device is playing. The First Device can also send the Content Specifier. The at least one time data item or Content Specifier can be received by the Second Device. The Second Device can receive the Content Specifier from the First Device or the Content Specifier can be input by a User. The User can make a command entry, such as a button push, screen touch, gesture, voice command, text entry, or menu selection, at the point within the time-based media content that the User is interested in. The Second Device can send the Content Specifier, command, time of the command within the content, or actual time to the Third Device. The Third Device, based on these data, can determine pertinent information or the address thereof, and can send at least one of these to the First or Second Device. For example, a computer or television set can play audio or video content from a file, a web site, or a server, the computer can transmit the identity of the content or the time a User command within the content, this transmitted information can be received by a mobile telephone, a User can enter a command into the mobile telephone at upon seeing or hearing interesting content in the content, the mobile telephone can send to a Server the identity of the content and the time within the content that the User made the command, and the Server can send, to the mobile telephone, computer, or television set, a web site address and the mobile telephone, computer, or television set can access information at that web site.

As an alternative to using the time within an item of time-based media, the actual time at which such time-based media started playing in combination with the actual time of a command can be used to determine the time of the command with the time-based media.

Another aspect of the inventive subject matter is control of a First Device by a Second Device. The Second Device can be a mobile network-connected device. In this aspect, a) the Second Device can be a mobile telephone, b) the Second Device can communicate with a Third Device, which can be a server, via a network such as the Internet, or c) the Third Device can communicate with the First Device via a network such as the Internet. The First Device can send Communication Information to the Second Device, said Communication Information being information sufficient for the Third Device to establish communication with the First Device. The Communication Information can be a network address, such as an IP address, of the First Device. The Communication Information can be sent via radio frequency, optical, wire, or other network or communication means. The Second Device can send, to the Third Device, the Communication Information and a command description pertinent to the First Device, via a network such as the Internet. The selection of the command description and the initiation of sending the command description and Communication Information to the Third Device can be initiated by a User, the First Device, or the Second Device. In some embodiments the command description can include a request to, for example, change a channel or perform another at least one action that can be performed by the First Device. Based on the Communication Information and the command description, the Third Device can send at least one command to the First Device and the First Device can execute, store, or otherwise process the at least one command. In some embodiments the First Device can be a television set, the Second Device can be a mobile telephone, the Third Device can be a server, and the mobile telephone can be used as a remote control device to control the functions of the television set. In other embodiments, the Second Device can be a mobile telephone, the Third Device can be a server, and the First Device can be a network-connected device that can be controlled via the mobile telephone. Examples of such First Devices are vending machines, automobiles, computers, printers, mobile telephones, audio playback equipment, portable media players (e.g. iPod), radios, toys, or medical equipment.

In some embodiments the Communication Information is sent from the First Device to the Second Device, stored in the Second Device, and the Second Device sends the stored Communication Information to the Third Device. Storing the Communication Information in the Second Device eliminates the need to send the Communication Information from the First Device to the Second Device each time the system or process is used. This technique comprises “pairing” of the first and Second Devices to, for example, eliminate the need for human intervention or authentication upon each use of the system. In some such embodiments the Communication Information pertinent to the First Device can be entered into the Second Device by a human, software, or a device, rather than be sent from the First Device to the Second Device.

In some embodiments the Communication Information comprises information identifying the Second Device rather than the First Device. In such embodiments the Third Device stores or otherwise has access to information associating Communication Information related with the Second Device with Communication Information related to the First Device, and the Third Device communicates with the First Device by determining the Communication Information of the First Device based on the Communication Information of the Second Device. For example, the Third Device can determine a network address of the First Device based on the identity of the Second Device, given an information mapping between Second Device Communication Information and First Device Communication Information. As an example, the Second Device can be a mobile telephone, the Third Device can be a server, and the server can determine the IP (or other) address of the First Device by looking up such address in a database that relates the IP address, telephone number, UUID, or other identifier of the mobile telephone with at least one First Device that the mobile telephone is related (“paired”) to. Multiple First Devices can be related to a Second Device and in such cases the particular First Device to be commanded can be selected from among the multiple First Devices that are related to the Second Device. This selection can be performed, for example, by a User selecting the particular desired First Device via a menu, keyboard, screen item, or other User interface construct in or on the Second Device. The selection of a First Device to be commanded need not be limited to one First Device; a command can be sent from the Second Device to multiple First Devices, via the Third Device.

In some embodiments the First and Second Devices can be present in the same device. For example, the First Device can be a television receiver that is incorporated in a mobile telephone (the Second Device).

Another aspect of the inventive subject matter is a technique to mitigate errors in the Content Selection Time. In some embodiments, media content can be transmitted from a source to a First Device. Such transmission can introduce a time delay that can in turn introduce a time error in the Content Selection Time. Furthermore, errors in the determination of the Content Selection Time can be introduced by, for example, time errors in the clock used as the reference for such time (e.g. an internal clock in a mobile telephone). Such time errors can result in a difference between the time that the media content is processed or displayed by the First Device and the time, of processing or display of the same media content, that is available to or known by the Third Device. Such a time error can be reduce by adjusting the Content Selection Time, as received by the Third Device by, by the estimated time error. The time error can be estimated by sending a time-coded calibration signal to the Second Device via the transmission means that is carrying the media content. This calibration signal includes the time of original transmission of the calibration signal from the source that is transmitting the media content. The calibration signal (the transmission time) can be received by the First Device, which is playing the media content, and then sent to the Second Device, or it can be received by the Second Device. The Second Device sends, to the Third Device, the original transmission time and the time at which the calibration signal was received by the Second Device, as determined by the Second Device. The Third Device can estimate the time error as the difference between the original transmission time and the time of receipt of calibration signal sent by the Second Device. The estimated error includes errors due to network transmission and to clock errors. This calibration process can be executed periodically, thus accommodating time varying errors such as might arise as a mobile device moves and changes between RF or cellular stations.

Another aspect of the inventive subject matter is interaction with content or a device without specification of the Content Specifier. The Content Specifier can be determined based on the identity or address of a Second Device, the User of the device, or time. This technique can be used instead of explicit provision or sending of the Content Specifier. The Content Specifier can be associated with a Second Device, and thus based on the identity of the device the Content Specifier can be determined. For example, a Second Device (such as a mobile telephone or a computer) or software therein can be associated with a media stream (such as a television channel, or streaming audio or video in a web site or other network media source). A message is sent from the Second Device to a Third Device (such as a server) via a network such as the Internet. The message includes the identity or address of the Second Device or software therein. Based on that identity, address, or the time, the Third Device can determine the Content Specifier or can determine the appropriate response or destination to which commands, based on the combination of time, identity, or address of the Second Device (e.g. mobile telephone or software application therein), can be sent. For example, a particular Second Device can be associated with a particular content channel, and upon receipt of a command from the Second Device, a server can provide information or an address thereof based on the content channel associated with the Second Device or the time. In some embodiments, the Content Specifier can change as a function of time such that a particular Second Device or software application therein can be associated with different media channels, streams, sources, or providers (together, “media sources”) as a function of time, via, for example an mapping of time periods with media sources. Such mapping can be stored in a database, computer memory, computer file, or other data storage and access mechanism. As an example, a software application in a mobile network-equipped device, such as a mobile telephone, can be used by viewers of a media channel. A User can interact with media content in that channel by interacting with the software application. A User can command the software application, the software application can send a corresponding message to a server, and the server can determine an appropriate response based on an identity of the mobile device, a network address of the mobile device, or the time, or any combination of these. If the User provides a command while observing or listening to media content then the server can identify the content based on the identity or address of the mobile device or software therein and the time. The media source can be identified based on the identity or network address of the mobile device or software therein, or deduced simply from the fact that there is any communication from the device to the server (e.g., only software applications from a specific media source can communicate with a server related to that media source). The action taken by the server can include changing a television channel, affecting or otherwise interacting with programming or content, voting, or sending information, content, or commands to a network-equipped device, mobile device, or mobile telephone.

In some embodiments the User may wish to interact with or obtain information related to content that is not played under the control of a content source. Television and radio programming are played under the control of television and radio stations; such a station controls the content that is played and the time it is played at. Content that is distributed via the Internet, however, can be controlled by a User. A User can determine what content is played and at what time. This poses a difficulty for the previously mentioned Second Device or server to determine what content a User is observing, playing, or otherwise interacting with at any given time. Another aspect of the inventive subject matter enables the Second Device or server to identify the content in this scenario. In this aspect, the User is observing, playing, or otherwise interacting with content via a First Device. The choice of content and the time at which the content is played or displayed can be determined in an ad-hoc fashion and can be unpredictable. The identity of the content being played by the First Device or the time within the content can be determined from the First Device (e.g., a television set or web browser can determine the identity of content or a content channel or stream that is playing) or from the source of the content (e.g., a web site can send the identity of the content via a network). If the identity of the content or the time within the content is provided by a content source then that information can be sent from the content to source to the First Device, Second Device, or Third Device. For example, a web site serving streaming video to the First Device can provide (to the First, Second, or Third Device) the identity of a video being played by the First Device and the time within that video. The Second Device can identify content being played by the First Device by a) receiving the Content Specifier from the content source, b) the Second Device being used as a control device to command a First Device and thus having access to the identity of a content channel or stream that the User selects, or c) receiving the Content Specifier from the First Device. An example of case (b) is a mobile telephone used as a remote control for a television, computer, or other device that plays media content, and thus having access to the channel, web page, URL, radio station selection, or other specification or address of content. The Third Device thus can receive the Content Specifier from one or more of the above sources, a command from the Second Device, or the time as described above, and can then provide information, an information address, send a command or message, initiate a software process, or take other action. Via this technique the process can be performed in a case where the content is selected in an ad-hoc fashion, i.e. without a predetermined schedule.

In some embodiments a software application in the Second Device can be associated with a content channel or stream (e.g. a television station or web site) and activity (e.g. a message or command) from that software application can indicate, to the Third Device, that the Content Specifier is related to the content channel or stream associated with the software application. For example, a software application in a mobile telephone can be associated with a content channel or stream.

In some embodiments the First Device and Second Device are integrated into a single device. For example, media content (e.g. audio or video) can be played in a mobile telephone. In such embodiments the Content Specifier can be determined as the identity of the content stream (e.g. the television channel or web video) that is being played. User inputs to the devices described in the inventive subject matter can be made via any mode, including text, menu, mouse, movement or orientation of an input device, speech, or touch-sensitive screen.

The Content Selection Time can be determined or provided by a User, or the Content Selection Time can be determined or provided by a device or component. Such a device or component can consist of hardware, software, or both. The Content Selection Time can be the real time (i.e. the “current wall clock time”) at which a User makes an action or can be the time indication of such action is received by a component. For example, the Content Selection Time can be the Greenwich Mean Time or Local Time at which a User takes an action (e.g. presses a button on a device) or can be the Greenwich Mean Time or Local Time at which an indication or result of such action is received a device (e.g. a server). As described previously, the Content Selection Time can be adjusted to compensate for network transmission delays or other errors. The Content Selection can be a time relative to a reference point within the Content of Interest and can be measured according to a timeline within the Content of Interest. The Content Selection Time can be measured in frames (e.g. video frames) or other such content intervals other than time. Embodiments that base the Content Selection Time on real time (as opposed to a time scale, frame count, or other time scale within the Content of Interest) can function without the use of video time codes, audio time codes, or other reference scale related to the Content of Interest or media. In other words, measuring the Content Selection Time in real time (i.e. actual time) obviates the need to read or write time codes within the media (content). Use of real time rather than time based on a scale within the Content of Interest enables the inventive subject matter to function without the need for time information based on a scale within the Content of Interest. In other words, time within media content, frame count, or other such information indicating a point within time-based media content is not used.

Measuring the Content Selection time in real-time, as opposed to a time scale or other reference (e.g. frame numbers) tied to the media content itself, enables the inventive subject matter to perform hyperlinking of broadcast content, e.g. video, television, audio, or radio without the need for hyperlink information. In other words, it is not necessary to provide hyperlink information embedded in the content or via any other mechanism. They hyperlink destination is determined from at least one of: the identity of the content stream being viewed by the User, the time that a User provides a command or makes an action, the nature of the command or action provided or taken by the User.

The action taken or command provided by a User can be one or more such actions or commands selected from a plurality of options. For example, a User can a) select an item from among multiple choices, b) perform a gesture with a device, said gesture being one or more possible gestures among several that can be sensed by the device, c) provide a voice command or selection, d) press a button, or e) select an item from a menu or other multiple-choice user interface mechanism.

The action or command can cause a result other than a hyperlink. For example, via such action or command, a User can a) interact with a television program, b) change a channel, c) perform a transaction, d) control the playing of audio, video, or other media, or e) perform any interactivity that can be performed over a network such as the Internet. The action take or command provided by a User can comprise or result in multiple commands or items of information.

The command options, hyperlinks, or information resulting from execution of such commands or hyperlinks can be presented to a User concurrently with media, such as the Content of Interest. For example, video content can be displayed to a User in one portion of a device screen and hyperlinks or other command options (such as buttons or menus) can be displayed to a User in another portion of the device screen. The interactive objects (hyperlinks, command options, user interface controls, or the like) can be overlaid upon or intermixed with the media content.

In some embodiments the User can select a media channel, such as a television channel. In some embodiments the media channel or Content Specifier is included in the command or commands sent, for example, from the Second Device to the Third Device. For example, a command set can comprise a channel identifier and a command. A third preferred embodiment is described as follows:

The inventive subject matter provides for a) changing the target URLs of hyperlinks as a function of time or b) time-based sequences of web pages in a browser. A time-based URL mapping system and process can accomplish both of these functions.

Time-Varying Hyperlinks

The inventive subject matters can involve a time-based mapping between requested URLs and displayed URLs. This can enable the URL of a hyperlink to change over time. The original URL (the “input URL”) of a hyperlink can be mapped to a new URL (the “output URL”) based on time. An array, table, database, or other information store can include one or more output URLs for an input URL, and a time associated with each output URL.

For example, a data structure such as the following can be used:

| Input URL | Output URL | Time |
|---|---|---|
| http://aaa.com | http://111.com | D |
| http://aaa.com | http://222.com | E |
| http://bbb.com | http://fff.com | F |
| http://bbb.com | http://fff.com | G |

In this example, the URL http://aaa.com is mapped to 2 other URLs as a function of time. If that URL is requested between time D and E then the client (for example, a web browser) goes to http://111.com. If requested after time E the client goes to http://222.com. If requested before time D then the client goes to the original URL (http://aaa.com) with no remapping.

The above example uses times as the beginning of the period at which a specific remapping is valid. Alternatively the end of a period can be used, or both the beginning and end of a period.

The process can be as follows:
1. Client navigates to a web page.
2. Code in or called by the web page downloads to the client. Such software can be JavaScript, Flash, or other client-side language.
3. The code determines the current web page's URL.
4. The code sends the web page URL to a server.
5. The server looks up the web page URL and the current time to determine an Output URL appropriate at this time.
6. The server sends to the client the currently scheduled URL. This can be an Output URL from the table or (if no Output URL is currently applicable) the Input URL.
7. If the currently scheduled URL is different than the current Input URL then the client goes to the web page at the currently scheduled URL. Otherwise the client remains at the Input URL web page.

Time-Sequenced Web Pages

An aspect of the inventive subject matter enables accessing a sequence of information resources, such as web pages, in a client such as a web browser. The term client here refers to any device or software capable of accessing an information resource at an information address (such as a URL) over a network (such as the Internet). The description here uses Internet web pages as an example but the same concepts can be applied to other domains, information types, and networks.

The general process of the inventive subject matter can include a client accessing an information resource and then receiving or interacting with a sequence of information resources. The sequence of information resources can be provided to the client without additional action by the user (such as a human) of the client. A sequence of information resources (e.g. web pages) can thus be provided to a client in synchronization with other events. The provided resources can be entire web pages or portions of web pages. The other events can be, for example, a television program, a radio program, or a live event (such as a concert).

This technique and system can be used to enable 2-way interactivity with media that conventionally are 1-way. For example, a web page or sequence of web pages can be sent to a client according to a time schedule such that the web page contents are synchronized with television or radio programming. A user can interact with the web pages. For example, such web pages can provide information pertinent to the television or radio programming. Such information can comprise an opportunity to purchase a product. A user can thus purchase a product advertised via television or radio. Thus, a user or client can receive a sequence of information resources (e.g. web pages) based on the action of accessing a single information resource (e.g. web page).

The inventive subject matter can include the following steps or components:
1. Software can be added to a web page to enable time sequencing. The software can be in the web page or can be called from the web page and downloaded when the page is loaded by a client. For example, JavaScript, Flash, or other web client scripting language can be used. Some embodiments of the inventive subject matter utilize such client-side scripting software while some do not.
2. A schedule of at least one “event” is created or stored in a Server, where “event” means a mapping of an input information address (“Input URL”) to an output information address (“Output URL”) and a time period during which said mapping is valid. The time period can be a) between a start time and an end time, b) from a start time onward to any time in the future, or c) from any time in the past until an end time.
3. A client can access a web page that can include the software mentioned in Step 1 above. The URL of the web page can be determined and sent from the client to the Server mentioned in Step 2. The determination of the URL and sending of the URL to the Server can be performed by client-side software in a language such as JavaScript or Flash.
4. The server can receive the URL (the Input URL) from the client. The server can determine the currently scheduled URL, from the schedule, based on the Input URL received from the client and on the current time. The currently scheduled URL is an Output URL that, according to the schedule, corresponds to the Input URL and the current time. If the currently scheduled URL is different than the Input URL then the server can send the currently scheduled URL to the client and the client can access the web page at the currently scheduled URL.
5. The server can determine, from the schedule, the next event after the current time and can send this information (Output URL and associated time) to the client. Such a next event can comprise a mapping of the currently scheduled URL to a different Output URL. The client can receive this information and can then access the web page at that next Output URL at its associated time. Client-side web scripting software can receive the next Output URL and associated time, wait until that time, and then accesses the next Output URL. In this manner a sequences of web pages or other information resources can be accessed by the client according to a time schedule. Such web pages can each include the client-side software, or references to such software, that perform the client-side operations described above.

Time-Dependent Hyperlinks

Another aspect of the inventive subject matter consists of changing the destination information address of a hyperlink as a function of time. This can be accomplished via the same mechanism as described above except without sequences of events. The time-sequenced aspect of the inventive subject matter may be thought of a series of information resources (e.g. web pages) being accessed as a result of accessing one resource within the series. For example, such a sequence may consist of the following:

| Input URL | Output URL | Time |
|---|---|---|
| URL-A | URL-B | Time1 |
| URL-B | URL-C | Time2 |
| URL-C | URL-D | Time3 |

This data structure is for illustrative purposes only. Any structure that adequately describes the sequence of events is possible.

In a time-sequenced aspect of the inventive subject matter, if a client accesses any Input URL in the sequence then the client is redirected or otherwise accesses the Output URL corresponding to said Input URL and the current time. Furthermore, the client will continue to be directed to subsequent Output URLs in the sequence at their corresponding times.

In the time-dependent hyperlink aspect of the inventive subject matter an Input URL is mapped to different Output URLs as a function of time. There can be one or many different Output URLs. In the time-dependent aspect the same data structure as in the time-sequenced aspect can be used, but rather than comprising a sequence of events in which one leads to another, the events can constitute mapping one Input URL to one or more Output URLs as a function of time. For example:

| Input URL | Output URL | Time |
|---|---|---|
| URL-A | URL-B | Time1 |
| URL-A | URL-C | Time2 |
| URL-A | URL-D | Time3 |

In this example, URL-A maps to 3 different URLs as a function of time. If a client accesses URL-A between Time1 and Time2 then the client can be redirected to URL-B. If the client accesses URL-A between Time2 and Time3 then the client can be redirected to URL-C, and so on.

General

The time-sequenced and time-dependent hyperlink aspects of the inventive subject matter can be mixed. A schedule can include events to lead to other events (e.g. URL-A leads to URL-B which in turn leads to URL-C) and can also include events that do not lead to other events (e.g. URL-A leads to URL-B or URL-C at different times). The same information structure, algorithms, or components can be used to provide both aspects. The client, server, or user can be a) distant or nearby each other, b) combined in any combination (e.g. the client and server can be in the same device), or c) connected via a network (e.g. the Internet).

In this document, time is used as a basis to schedule and determine information addresses. Other attributes can be used as a basis and basis attributes can be combined. For example, information addresses can be scheduled or determined based on location, client address (e.g. Internet Protocol (IP) address), web browser type/identity (e.g. user agent), client device type (e.g. computer type, mobile device model), language, or history of past URLs accessed by the user or client. Output URLs can be determined on any combination of such data.

The inventive subject matter has been described in this document in terms of web pages as information resources and web browsers as clients. These terms are used due to their familiarity. However, the inventive subject matter is applicable to any type of information resource or client, not just web pages and web browsers.

A fourth preferred embodiment is described as follows:

Glossary

Certain terms used in this fourth preferred embodiment are defined as follows:

“Media Stream” means an item of time-based media, such as video or audio.

“Mobile Phone” means any device capable of capturing a portion of a Media Stream (e.g., via microphone or camera) and sending such portion to a destination via a network, such as the Internet. A Mobile Phone includes the functionality, such as via a web browser, to access information via a network such as the Internet. A Mobile Phone can be a mobile telephone, a personal digital assistant, or a computer.

“Media Sample” means a portion of a Media Stream. Media could come from the following:

“Media” means
Media (communication), tools used to store and deliver information or data
Advertising media, various media, content, buying and placement for advertising
Electronic media, communications delivered via electronic or electromechanical energy
Digital media, electronic media used to store, transmit, and receive digitized information
Electronic Business Media, digital media for electronic business
Hypermedia, media with hyperlinks
Multimedia, communications that incorporate multiple forms of information content and processing
Print media, communications delivered via paper or canvas
Published media, any media made available to the public
Mass media, all means of mass communication
Broadcast media, communications delivered over mass electronic communication networks
News media, mass media focused on communicating news
News media (United States), the news media of the United States of America
New media, media that can only be created or used with the aid of modern computer processing power
Recording media, devices used to store information
Social media, media disseminated through social interaction
Media Plus, European Union program
Or as more generally understood to be a television, internet, or radio broadcast

“Database Media Sample” means a portion of a Media Stream that is stored in a Server. A Database Media Sample can comprise, in whole or part, one or more still images, or any other type of information to which a User Media Sample can be compared against to identify the User Media Sample.

“User Media Sample” means a portion of a Media Stream that is captured by a Mobile Phone. A User Media Sample can be captured, for example, by a microphone in the Mobile Phone capturing audio emanating from a Television Set. A User Media Sample can comprise, in whole or part, one or more still images, or any other type of information that can be compared against a Database Media Sample to identify the User Media Sample.

“Television Set” means a device capable of playing a Media Stream. A Television Set can be a conventional analog television set, a digital television set, or a computer.

“Set-Top Box” means a device that sends and receives commands, via a network, as an intermediary between a Television Set and another device. The another device can be a Server.

“Server” means a device that can send and receive commands via a network such as the Internet. A Server can include processing functionality, such Media Stream recognition.

“User” means an entity that uses a Mobile Phone or Television Set. A User can be a person.

“Imagery” means any combination of one or more still images, video, or audio.

“Time-Shifted Media” means time-based media, such as audio or video that, rather than being played to at a pre-defined time, can be played at any time, such as on demand by a User. Such time-shifted media can be (a) media that is streamed via a network, (e.g. Internet video) (b) media that is downloaded via a network and then played, (c) media that has been recorded and subsequently played later (e.g. recorded from television via a video recorder), or any combination of these.

Introduction

Image recognition, audio recognition, video recognition, or other techniques can be used to identify a Media Sample. This identification can then be used to take an action pertinent to the Media Sample. For example, sounds (such as music) can be identified by capturing sound with a Mobile Phone, sending the captured sound to a Server, and comparing the captured sound sample to a database of sounds, and the identity of the sound can then be used to direct the Mobile Phone User to an online resource via which they can purchase something (e.g. the music) or pursue other pertinent interaction. Similarly, video can be identified by capturing Imagery, e.g. by capturing an image of a television screen or computer display screen with a Mobile Phone, sending the Imagery to a Server, and comparing the captured Imagery to a database of Imagery. The identity of the video can then be used to direct the Mobile Phone User to an online resource, e.g. to obtain information or make a transaction pertinent to the video.

Such approaches involve comparing a Media Sample, captured from a Media Stream, to a database of audio or Imagery. A challenge involved in this approach is that the size of the database depends on the size and quantity of Media Streams that must be matched. For example, in order to provide a User the ability to match all television programming over a certain time period, then all video from all television channels available to a User over that period must be stored in the database. Large databases can involve large resource requirements, in terms of computational processing time (to ingest, process, or search the database), computational memory, computational disk space, human labor, logistics, or other resources. Furthermore, it can be problematic to obtain the many Media Streams that may be available to Users.

The inventive subject matter involves, among other things, techniques that can reduce the resources required in identifying a sample of a Media Stream. Any and all functionality assigned herein to the Mobile Phone, Television Set, Server, Set-Top Box, or User can be arbitrarily distributed among such components or entities.

Efficient Media Recognition

A. One technique to facilitate identification of a Media Sample or Media Stream is to limit the database search to the database content that is close in time to the Media Sample. Database media contents can have a time attribute. A database search can be limited to those database contents whose time attribute is within some limit of the time of the Media Sample. The time limit can be a fixed value or can vary.

B. Another technique is to limit a database search based on physical distance. This distance can be between the location of the Media Sample and database media contents (e.g. database media contents can have a location attribute). This technique can involve obtaining the location where the sample was obtained and limiting the database search to database contents related to that location. For example, the location of a Mobile Phone can be determined via IP address, Global Positioning System, RF triangulation, or other means, and a Media Sample captured by such Mobile Phone can be compared to database objects that are related to the location, or area containing the location, of the Mobile Phone.

C. Another technique is to obtain the Media Streams by capturing them as they are transmitted by media providers. The media providers can be broadcast, satellite, cable, Internet-based, or other providers of audio or video media content. The Media Streams can be captured prior to the time that Media Samples are received. This technique can involve the following steps:
1. Capturing a Media Stream by receiving it (for example, by receiving a television or radio program);
2. Storing the Media Stream or data derived therefrom (for example, storing the audio from a radio program, or storing still images extracted from a video stream, etc.) in a database. This step can involve processing the Media Stream or data. The database can be in a Server.
3. Capturing a Media Sample. This can be done, for example, by capturing a video sample or still image from a TV program, capturing an audio sample from a TV program, or capturing an audio sample from a radio program or other audio source. The Media Sample can be sent to a Server via the Internet or other network.
4. Identifying the Media Sample by comparing it to media stored in the database. The Media Sample can be compared only to database contents that have been recently (within some time limit) captured or derived from one or more Media Streams.
5. Because the Media Samples are derived from real-time Media Streams, it is not necessary to keep media in the database after a period of time. In other words, if only real-time Media Streams are to be recognized then Media Streams need not be retained in a Server for long periods of time.

This last technique (C) has several benefits. First, it obviates the need to obtain the Media Stream contents from the providers of such streams. Instead, the Media Streams can be collected in real-time. Second, the database size can remain small by discarding older database contents.

Example Process

A Server can capture live audio from all of the television channels available to a User. The Server can store the captured audio. The Server can discard audio that is older than some time limit (for example, 1 minute). A Television Set can carry or display a television channel. A Mobile Phone can capture ambient sound from the television channel, via audio produced by the television set, and can send it to the Server. The User can change the television channel. The Mobile Phone can capture the sound, from the new channel, and send the captured sound to the Server. The Server can compare the captured sound to the audio that it previously captured from the multiple television channels. The Server can identify the channel that the User was watching by matching the sound from the Mobile Phone to a sound sample that it captured from the television channels. Based on the particular channel that was identified, the Server can send information to the Mobile Phone. The sent information can be a command, an information address, an internet URL, a web site address, or other information that can be pertinent to the television channel or the content that the User was watching on that channel. The Mobile Phone can receive said sent information and use it to perform an action. Said action can consist of going to a web page, initiating a software process, etc. In the case that the action comprises going to a web page, the web page can include information pertinent to the content (i.e. the television show) that the User was watching. The web page can be one of several web pages in a time sequence that corresponds to a television program. Such sequenced web pages can be sent to the Mobile Phone in synchronization with a television program, so that the Mobile Phone displays information corresponding to the television program on an ongoing basis. A Server can contain different sequences corresponding to different channels that a User might watch. The Server can send a command or information address to the Mobile Phone and the Mobile Phone can use the command or information address to access an online resource, such as a web page or a sequence of web pages, that corresponds to the channel carried by the television set.

Thus, a User can receive information or contents, via a Mobile Phone, that correspond to television content on a television channel, and if the User changes the television channel then the content received via the Mobile Phone can be changed accordingly, to correspond to the new channel. The content received via the Mobile Phone can comprise a “Virtual Channel,” i.e., a sequence of information resources or addresses, and via the inventive subject matter the Virtual Channel can be changed automatically based on a change in the television channel.

Generalization of the Process

All of the items in this section apply the above “Example Process.”

The Server can be distant from or close to the Mobile Phone. The Server and Mobile Phone can be (a) connected by a network, such as the Internet, wire, optical, or radio frequency network, (b) attached to each other, (c) or parts of one device.

The television channel can comprise any time-based media, such as audio or video. It can come from a television station, a server via the Internet, or other transmission means. The Server need not store Database Media Samples from all available channels. The Database Media Samples can be from television, radio, audio, video, satellite, cable, or other types of media and distribution mechanisms. There can be any number of Database Media Samples. The Database Media Sample can be stored by the Server in a database, in memory, in volatile or non-volatile storage, or via other storage means. The Database Media Sample need not be captured in real-time from broadcast media. The Database Media Sample can be obtained in non-real-time. The Database Media Sample can be obtained prior to the time that the corresponding Media Stream is broadcast and then stored in the Server.

The web page(s) can be any information or resource that the Mobile Phone can access. The Mobile Phone can capture a Media Sample from the Television Set via ambient sound in the air, via a camera imaging the visual display or screen of the Television Set, or via a connection (wire, RF, optical, or otherwise) to the Television Set.

A User Media Sample can be processed to remove unwanted information or signal. For example, ambient sound (i.e., sound other than the sound from a television program) can be suppressed. Such processing can be done in the Mobile Telephone, the Server, or both. Similarly, a Database Media Sample can be similarly processed by the Server. Any and all the functions in the above example process, including any and all functions described in this “Generalization of the Process” section, can be arbitrarily distributed among the Television Set, Mobile Phone, or Server.

Application to Time-Shifted Media

In addition to broadcast time-based media the inventive subject matter can be applied to Time-Shifted Media. The process for Time-Shifted Media is similar to the process described above but with the following modifications. To accommodate media contents recorded from television, the Database Media Sample can be stored in the database for the duration of the period during which such content is to be recognized. In the Example Process above, this database retention time can be relatively short (e.g., on the order of 1 minute) because the Example Process is based on recognition of live media. However, if the media is recorded and then later played and recognized then the corresponding Database Media Sample can be retained in a Server for a longer period, because a User can play the recorded media, and thus provide a User Media Sample, long after the Media Stream was broadcast or recorded, and in order for the Server to identify such User Media Sample the Server can retain the corresponding Database Media Sample at least until such time as the User Media Sample is received. This can involve storage for longer periods, e.g. on the order of months or years. Via comparison (e.g. sound recognition, image recognition, or other technique) between the User Media Sample and at least one Database Media Sample, a Server can identify the User Media Sample that sent from the Mobile Phone or other device. In particular the Server can identify (a) the Media Sample from which the User Media Sample was derived or (b) the portion of the Media Sample that User Media Sample corresponds to. Via such technique a Server can identify a particular portion of the media. Thus, the inventive subject matter can identify and provide information related to a Media Stream, or portion thereof.

To accommodate media contents recorded from television, the Database Media Sample can be stored in the Server prior to the contents being broadcast, e.g., the contents can be obtained directly from a television content producer. For example, a User can record a television program on a digital video recorder. The same program can be recorded, or otherwise obtained and stored, by a Server. The User can play the program at a later time and a Mobile Phone can capture and send audio from the played program to the Server. The Server can compare the audio to stored audio, identify the portion of the stored program to which the audio matches, and send to the Mobile Phone information related to the identified portion of the stored program.

To accommodate media contents streamed or downloaded from a network such as the Internet, the Database Media Sample can be obtained in non-real-time. For example, Internet videos or audio files can be downloaded or otherwise transferred or copied from a web site or other server to the Server. For example, (a) a video can be downloaded to the Server from a web site that streams or provides downloads of videos, (b) the Server can store part or all of the video, (c) a User can play the video, (d) a User Media Sample (e.g. a portion of the audio) can be captured from the video by a Mobile Phone, (d) the Mobile Phone can send the User Media Sample to the Server, (d) by comparison between the User Media Sample and at least one Database Media Sample, the Server can identify the User Media Sample as being a portion of the video downloaded in step (a), (e) the Server can identify the User Media Sample as corresponding to a particular portion of the Database Media Sample, and (f) the Server can send to the Mobile Phone information or an information address related to the Database Media Sample, or portion thereof, that corresponds or matches with the User Media Sample. Database Media Samples obtained in real-time by capturing broadcast media can be used to identify User Media Samples obtained from network streamed or downloaded media. For example, a television show can be recorded by a Server, from a broadcast source, a User can later play that show on a video web site, a Mobile Phone can capture and send audio from the video to the Server, and the Server can recognize the show and send corresponding information to the Mobile Phone.

Continuous Update

A Mobile Phone can send one or more User Media Samples to a Server on an ongoing basis. For example, a Mobile Phone can periodically capture audio samples and send them to a Server, or a Mobile Phone can continuously capture audio and send the audio to the Server. A Server can receive such ongoing User Media Sample(s). The Server can, on an ongoing basis, identify the ongoing User Media Sample(s). The Server can, based on changes in the identity of the ongoing User Media Sample(s), send information or a command to the Mobile Phone. The Mobile Phone can, based on said sent information or command, display or provide information or content related to the Media Stream that was the source of the User Media Sample(s).

In this manner, a Mobile Phone can be synchronized with other media or devices. For example:
1. A User can be listening or observing a Media Stream (e.g. via broadcast television or Internet video).
2. A Mobile Phone can capture a User Media Sample from the Media Stream and send it to a Server. The User Media Sample can be audio captured from sound emitted from a device that is playing the Media Stream.
3. The Server can receive the User Media Sample, compare it to at least one Database Media Samples, and identify the Media Stream. The Server can identify the portion of the Media Stream that matches the User Media Sample.
4. The Server can send a command or information to the Mobile Phone, via a network such as the Internet.
5. The Mobile Phone can go to a web site or other information resource, or initiate a software process, based on the command or information sent from the Server.
6. The User can change to a different Media Stream (e.g., by changing a television channel or selecting another Internet video).
7. The Mobile Phone can repeat Step 2, on a continuous basis (continuous capture and sending of a User Media Sample) or on a repetitive basis (capture and sending of multiple User Media Samples).
8. The Server can receive a User Media Sample from the new Media Stream that the User is listening to or observing. The Server can identify the new Media Stream or portion thereof, via the process in Step 3.
9. The Server can send information or a command, related to the new User Media Sample, to the Mobile Phone.
10. The Mobile Phone can repeat Step 5 but in this case with a web site, information resource, or software process related to the new User Media Sample.
   The above process can repeat indefinitely.

Commanding From Mobile Phone

Previous sections in this document described a process in which a User can change a channel or other content selection, on a television, computer, or other device that can play time-based media, the User's new channel or selection can be identified, and then content or information corresponding to the new channel or selection can be provided to the User. This section refers to a process in which the content selection or channel change can be initiated from a Mobile Phone. All communication between components in this Section can occur via a network, such as the Internet.

A Mobile Phone can send a command to a Server. The Server can then send a command to a Television Set, or the Server can send a command to an intermediate device (the “Set-Top Box”) and the Set-Top Box can send a command to the Television Set. The Television Set can receive a command from the Server or the Set-Top Box and, based on that command, can change the content or channel that the Television is playing or displaying. The Server can use the command from the Mobile Phone to send information or a command to the Mobile Phone. The sent information or command can be an information address, such as a web site URL. The Mobile Phone can access such information directly, without receiving a command from the Server. Thus, a User can select a channel or content via a Mobile Phone, the Mobile Phone can communicate the selection to a Server, the Server can send corresponding information to a Television Set, either directly or via a Set-Top Box, and the Television Set can access or display the channel or other content related to the User's selection. Furthermore, the Mobile Phone can access information related to the User's Selection, either directly based on receipt of a command or information from the Server. An input from the User to the Mobile Phone can be made via keypad, touch screen, gesture, or voice. The User's input can be decoded or interpreted by the Mobile Phone or the Server. In the case of input via voice, voice recognition can be done in the Mobile Phone or in Server, and the voice recognition can be based on training to better recognize an individual User's speech.

A fifth preferred embodiment is described as follows:

Within this Section, the following definitions apply:

“URL” means an information address. Often this is a Uniform Resource Locator or web page address.

“web page” means any information resource accessible via a network such as the Internet.

“Client Device” means a device capable of communicating via a network such as the Internet. The Client Device can be a telephony device, such as a mobile telephone. Typically the Client Device has computing capability and a web browser.

“server” means a computer or computing device that can communicate via a network such as the Internet. A server can be a Client Device.

“Displaying a web page” means accessing information from and typically displaying the contents available from a Web Page.

“contents” can include HTML, XML, audio, video, graphics, or other types of information.

“Schedule” means information including at least one URL and at least one associated time. The Schedule can be a list with each entry in the list comprising: a first URL, a second URL, and an associated time.

“Record” means an entry in the Schedule.

A Client Device can access a first web page. Based on the address of the first web page, the Client Device can access a second web page at a specific time. The address of the second web page can be determined based on the address of the first web page. A Schedule can contain a mapping of first web pages to second web pages, with an associated time for each such mapping. The Schedule can be obtained by the Client Device via a network such as the Internet. The Schedule can be obtained from a server. A Client Device that has first accessed a first web page can access a second web page at the time in the Schedule associated with the mapping of the first to second web pages. The Client Device can repeat this operation such that the Client Device displays a sequence of web pages, with each such page displayed at the corresponding time in the Schedule.

The Schedule can be provided from a server to the Client Device. The Schedule can contain one or more mappings of first to second web pages. A mapping can include only a second web page, in which case the client accesses that second web page regardless of the URL that the Client Device is currently displaying.

The determination of a second URL, based on a first URL or a time, can be done in the Client Device or in a server. If done in a server, then a Client Device can send to a server the URL of a web page, such as the URL of the web page that the Client Device is currently displaying, and the server can determine the URL of the second web page and send such URL to the Client Device based on the first web page URL, the current time, or the time zone of the Client Device. This determination can be done by table lookup or database lookup.

A Client Device can poll a server to determine whether an update to a Schedule is available. A Client Device can retrieve an update to a Schedule if such update is available. The Schedule update can be retrieved from the same server that provides the indication that an update is available or from a different server. A server can send a message to a Client Device indicating that an update to a Schedule is available. The Client Device can then retrieve the Schedule update from a server. Such notification and retrieval can be done using the same or different servers.

A Client Device can access web pages in an ad-hoc fashion such that the sequence of web pages or the content of such pages is not known a priori. A Client Device can display a first web page. The address of a second web page can be determined in real time, for example, by a human. The content of the second web page can be determined in real time. The time at which the second web page should be displayed by the Client Device can be prescheduled or can be determined in real time. This technique can be used to provide contents, to the Client Device, that are related to events that are not predictable a priori, such as sporting events.

The Client Device can poll a server to determine if a second web page should be displayed. In response, the server can send to the Client Device a URL of the second web page or a time of the second web page. The Client Device can then access the second web page. The second web page can be accessed at the time provided by the server if such time is provided by the server.

The Client Device can poll a server to determine if a first web page should be refreshed (e.g. to obtain new content). If the server responds that the page contents have been updated then the Client Device can reload the web page to display its new contents. In this manner new contents can be displayed but at the first web page URL.

A server can send a message to a Client Device indicating that a second web page is available to be displayed or that a first web page should be refreshed. The Client Device can then retrieve the URL or time of the second web page from the server and display the second web page either immediate or at the provided time, or the Client Device can refresh the first web page either immediately or at the provided time.

Protocols such as Reverse HTTP, PubSubHubbub, or WebHooks can be used to implement the above techniques, resulting in new web contents or pages being in effect pushed to the Client Device rather than the Client polling for new pages. This can reduce server load or network traffic. The determination of a second URL, based on a first URL or a time, can be done by searching a database to find at least one match to the first URL. The determination of the second URL can further be based on the current time. For example, the next URL that a Client Device should display can be that second URL in the database that has (a) a corresponding first URL the same as the current URL displayed by the Client Device and (b) an associated time later than the current time but earlier than any other such entries with first URLs that match the current URL.

The matching of URLs can be based on exact (complete) matching, partial matching, or matching via regular expressions. For example, a Client Device can be displaying a first web page with URL “http://www.ripfone.com/action?a=3&b=5”. An exact match can be used, such that the first URL in the database must match this URL text exactly. Partial matching can be used, such that, for example, this Client Device URL would match to a database first URL that is “ripfone.com.” In this example, any Client Device URL including “ripfone.com” would result in a match to this database entry, regardless of the other characters in the URL other than “ripfone.com.”

The Client Device can preload web pages from a server and then display them at their scheduled time. Web page contents can be preloaded into a buffer that is not visible to the user and can then be made visible when the web page contents are to be displayed. This technique can reduce the delay involved in loading web pages as perceived by users and can increase the accuracy of the time at which web pages are displayed (i.e. they are displayed closer to their scheduled time by minimizing or eliminating on-screen loading time).

The time at which web pages are displayed by the Client Device can be based on a time provided by a server (as opposed to the time of the Client Device clock). The server time can be obtained by the Client Device by making a request for such time to a server, and the server sending the current time. The server time can be obtained by the Client Device by making an HTTP request, such as an HTTP head request, to a server, the server sending an HTTP response, and the Client Device obtaining the current time (Calibrated Time) from the HTTP response header sent from the server. The same technique can be used with protocols other than HTTP. The server used for time calibration can be the same server as the server that provides schedule or web contents, or it can be a different server.

The Client Device can detect a URL that is currently displayed by the Client Device, or a URL that is being loaded or has been loaded by the Client Device (e.g. in a browser). The URL detected in this manner can be used as the first URL in the processes described above. Thus, the Client Device can display a second web page, via the processes described above, the Client Device can then display a third page (for example, via redirection from the second web page, or via user activating a hyperlink in the second web page). The Client device can be programmed to detect the URL of the third web page and then use that as the first URL to determine the time or URL of a new second web page to be displayed by the Client Device via any of the techniques described above.

A Server can send a Schedule to a Client Device. The Schedule can include at least one information address. The Schedule can include at least one time associated with the at least one information address. The Schedule can include multiple sets of information (“Records”) with each Record including at least one information address and an associated time.

The Client Device can be programmed to use a Record to retrieve an item of information using at least one information address and an associated time from the Record. The Client Device can retrieve multiple items of information utilizing the information addresses and times in multiple Records. The Client Device can retrieve or access an item of information at an associated time in the Record.

The Schedule can be sent from a server to the Client Device in a file. The Schedule can be included in a software program sent from a server to the Client Device. The Schedule can be sent to the Client Device in response to a request from the Client Device. A Software Program including the Schedule can be sent to the Client Device in response to a request from the Client Device.

The Client Device can execute a software program that causes the Client Device to access content at least one information address in the Schedule. The Client Device can access the content at the at least one information address at a time in the Schedule corresponding to the at least one information address. The content at the information address can be provided by a Server.

The software program can be downloaded to the Client from a server, a computer, or a mobile device. The software program can be resident in the Client. The software program can be permanently installed in the Client, e.g., in firmware.

The Client can retrieve an item of information from an address in the Schedule at a time associated with the information address.

The Client can retrieve an item of information from an information address in the Schedule immediately upon receipt of the Schedule. The Client can retrieve an item of information from an information address after a time delay from the time of receipt of the Schedule. The Client can retrieve an item of information from an information address at a predefined time. The Client can retrieve an item of information from an information address upon occurrence of an event, for example, selection of an information item on the Client Device by a user (e.g., by clicking or pressing on the screen or on a button of the Client Device), or the passage of a time duration, or the arrival at a certain time, or the arrival of the Client Device at a certain location, or the Client Device being in a certain orientation.

In some embodiments the Client can receive one Schedule record at a time. The entire Schedule need not be known or defined but can be determined in an ad-hoc fashion. The records in the Schedule can be based on events that are difficult to predict, such as events within a sports game. Schedule records can be sent to the Client on an ad-hoc basis. Thus, the Client can be directed to retrieve or display information pertinent to real-world events on an ad-hoc basis without prior knowledge of the events. For example, if a certain player scores a goal in a football game, then a Schedule record including the address of a web site, including information pertinent to that player or to the goal he scored, can be sent to the Client, and the Client and then display such information to a user. In some embodiments there need not be a Schedule per se; instead multiple discrete Records can be sent to and utilized by the Client to obtain information. Such a discrete Record can be created on an ad hoc basis or can be created a priori and then sent to the Client at an appropriate time.

In some embodiments, the Client does not receive a Schedule directly but rather receives notification that a new Schedule is available or that the Schedule has changed. The Client can obtain such notification by (a) receiving a message from a server or (b) polling a server. If indication is received from a server that the Schedule has changed or a new Schedule is available then the Client can retrieve a new Schedule from a server. Various technologies can be used for such an embodiment, such as Reverse HTTP, PubSubHubbub, or WebHooks.

The foregoing description is, at present, considered to be the preferred embodiments of the present discovery. However, it is contemplated that various changes and modifications apparent to those skilled in the art, may be made without departing from the present discovery. Therefore, the foregoing description is intended to cover all such changes and modifications encompassed within the spirit and scope of the present discovery, including all equivalent aspects.

What is claimed:

1. A system comprising a Client Device that queries a Server, a query from the Client Device to the Server contains an instruction, the Server receives the query and determines whether an information on the Server is newer than information on the Client Device and the Server updates the new information to the Client Device for display.

2. The system of claim 1, wherein the Client Device receives updates from the Server based upon information that is determined by an event external to the Server.

3. The system of claim 2, wherein the event may occur in real time.

4. The system of claim 2, wherein the event may occur at a predetermined time.

5. The system of claim 1, wherein the query is continuous.

6. The system of claim 1, wherein the query occurs at regular time intervals.

7. The system of claim 1, wherein the query is intermittent.

8. The system of claim 1, wherein the Client Device queries the Server and the Server updates the information to the Client Device with an instruction to display the information at a pre-determined time other than immediately upon receipt from the Server.

9. The system of claim 1, wherein the query from the Client Device also includes a date stamp.

10. The system of claim 1, wherein the Client Device determines whether the information is new for updating from the Server.

11. A system comprising a Capture Server that captures a media, a Database that stores the captured media, a Media Delivery Device, a Client Device that captures a media sample that is delivered by the Media Delivery Device and sends the media sample to a Recognition Server, the Recognition Server identifies the media sample by comparing the media sample against the captured media stored in the Database and updates information that is related to the media sample to the Client Device.

12. The system of claim 11, wherein the Database is on a continual loop, storing only the last twenty-four hours of media.

13. A system for redirecting an information request, comprising a Client Device that sends an information request to a Server containing a requested information address, the Server determines an information response based on the information request and the time of receipt of the information request, and updates information to the Client Device.

14. The system of claim 13, wherein the Server determines an information response from a pre-populated table.

15. The system of claim 13, wherein the Server determines an information response from a pre-populated table of events.

16. The system of claim 13, wherein the Server determines an information response based on events in real-time.

17. The system of claim 13, wherein the Server updates the information to the Client Device with an instruction to display the information at a pre-determined time other than immediately upon receipt from the Server.

18. A system for controlling content displayed by a Client Device comprising a Content Server that sends a content file to the Client Device and a Control Server that determines the content file that will be sent by the Content Server.

19. The system of claim 24, wherein the Control Server determines the content file by (a) overwriting the content file in the Content Server with another file or (b) setting a pointer, in the Content Server, that points to the address of the content file to be sent.
